(19) United States
(12) Patent Application Publication
(10) Pub. No.: US 2005/0011908 A1
(43) Pub. Date: Jan. 20, 2005

(54) Dispenser and pressure/vacuum converting machine

(75) Inventor: Hal C. Danby, Nr. Sudbury (GB)

Correspondence Address: Francis C. Kowalik;Baxter Healthcare Corporation, One Baxter Parkway, 32E, Deerfield, IL, 60015-4633, US

(73) Assignee: Baxter International, Inc.

(21) Appl. No.: 10/620,890

(22) Filed: Jul. 16, 2003

(51) Int. Cl. G01F 11/00

(52) U.S. Cl. 222/1

(57) ABSTRACT

A pressure/vacuum converting machine converts a positive fluid pressure input into positive and negative fluid pressure outputs. The machine also stores energy from the positive fluid pressure input for driving additional fluid pressure outputs. In one application, the pressure/vacuum converter forms a part of a dispensing machine which employs the pressure of water delivered to the machine into positive and negative air pressures used to dispense a beverage.

### BACKGROUND OF INVENTION

This invention relates generally to powered actuators and more particularly to a pressure/vacuum converting machine which employs line fluid pressure to power the machine.

Machines in the form of pumps for dispensing metered quantities of fluent material frequently employ an electric motor as the prime mover. The motor may be coupled to a hydraulic or pneumatic pump which powers operation of the machine, or it may directly drive a actuator acting on the fluid. One example of such a machine is a beverage dispensing machine of the type shown in co-assigned U.S. papent application Ser. No. 10/351,006, filed Jan. 24, 2003, the disclosure of which is incorporated herein by reference. A motor and accompanying equipment place certain limitations on the design of the dispenser. They require that the machine be connected to a source of electricity, and add to the cost of the dispenser, and also to the bulk of the dispenser. Moreover, the motor and accompanying equipment may generate significant acoustical noise in the operation fo the dispenser.

Dispensers of the type just described also frequently have valves associated with them to control the flow of fluent material. For example if the dispenser mixes two liquids and then dispenses them, it may be necessary to route the liquid within the dispenser. That will typically require one or more valves to accomplish. The valves themselves must be driven. Conventional drivers for such valves include pneumatic cylinders and solenoids. Pneumatic cylinders require a source of compressed air (e.g., from a compressor driven by the electric motor mentioned above). Solenoids require connection to an electrical outlet. In either case, the cylinder or solenoid take up space in the dispenser housing.

### SUMMARY OF THE INVENTION

The machine of the present invention is able to eliminate a prime mover in the form of an electric motor. In at least one embodiment, no electricity is required to operate the machine. The machine takes advantage of energy in the form of line pressure of fluid. For example, utility water is kept under a certain pressure so that it will flow. The present invention is able to convert the energy associated with the line pressure into motion of the machine. In a particular embodiment where the machine is used to dispense a mixture of water from a utility supply with an additive, the line pressure may be used to power movement of measured quantities of water and liquid. Moreover, valves used to control the flow of fluent material may also be beneficially driven by the line pressure.

In one aspect of the invention, a pressure/vacuum converting machine for converting an input force from an expandable bladder into at least one pneumatic actuation force comprises a pressure vessel adapted to receive at least a portion of the bladder therein. The bladder as received in the pressure vessel defines a gas volume not occupied by the bladder within the vessel. The gas volume of the pressure vessel decreases as the bladder expands thereby increasing the gas pressure in the gas volume. A pneumatic actuator is in fluid communication with the gas volume of the pressure vessel such that pressure in the gas volume drives operation of the pneumatic actuator.

In another aspect of the present invention, a fluent material dispenser powered by fluent material from a source of fluent material under pressure to act upon a flexible container to dispense fluent material used to power the dispenser. The fluent material dispenser comprises a first pressure vessel sized and shaped to receive a first portion of the flexible container therein in sealing relation with the flexible container first portion to define a gas volume within the first pressure vessel. A second pressure vessel is sized and shaped to receive a second portion of the flexible container therein in sealing relation with the flexible container second portion. A valve selectively connects the first portion of the flexible container to the source of fluent material under pressure such that the first portion is capable of expanding into the first pressure vessel to reduce the gas volume and increase the gas pressure in the first pressure vessel. A pneumatic actuator in fluid communication with the gas volume of the first pressure vessel is adapted for employing energy from the increased gas pressure caused by expansion of the first portion into the first pressure vessel to deflect the second portion and move fluent material within the second portion. The pneumatic actuator is also capable of storing energy to act on the first portion of the flexible container to displace fluent material therefrom when the valve is closed, whereby fluent material is dispensed.

In still another aspect of the present invention a method for dispensing fluent material using the pressure of fluent material from a source of fluent material under pressure comprises admitting fluent material under pressure into an elastic first bladder such that the first bladder expands in volume. Expansion of the elastic bladder is converted into positive gas pressure to drive a pneumatic actuator to effect one of expansion and compression of an elastic second bladder to move fluent material within the second bladder. Energy is stored from the positive gas pressure. Admission of fluent material under pressure into the first bladder is shut off. The pneumatic actuator is driven by the stored energy to compress the first bladder and to effect the other of expansion and compression of the second bladder for use in dispensing fluent material.

In a further aspect of the present invention, a pneumatic valve system comprises a valve including a cylinder and a piston biased to one of a valve open and a valve closed position. A pneumatic actuator in fluid communication with the valve is capable of applying at least one of a positive and negative pressure to the valve. The actuator is connected to the valve to move the piston against its bias to the other of the valve open and valve closed positions upon application of said one pressure.

### BRIEF DESCRIPTION OF THE DRAWINGS

FIG. 1 is a perspective of an orange juice dispenser constructed according to the principles of the present invention;

FIG. 2 is the perspective of FIG. 1 with a front door of the dispenser removed;

FIG. 3 is a front elevation of a flexible container of the present invention;

FIG. 4 is a section taken in the plane including line 4-4 of FIG. 3;

FIG. 5 is a schematic of the dispenser prior to activation;

FIG. 6 is the schematic of FIG. 5 subsequent to activation;

FIG. 7 is an enlarged, schematic longitudinal section of a pressure/vacuum converter of the present invention at one end of an outward stroke;

FIG. 8 is the pressure/vacuum converter in an intermediate position; and

FIG. 9 is the pressure/vacuum converter at an opposite end of its outward stroke.

Corresponding reference characters indicate corresponding parts throughout the several views of the drawings.

### DETAILED DESCRIPTION OF THE PREFERRED EMBODIMENTS

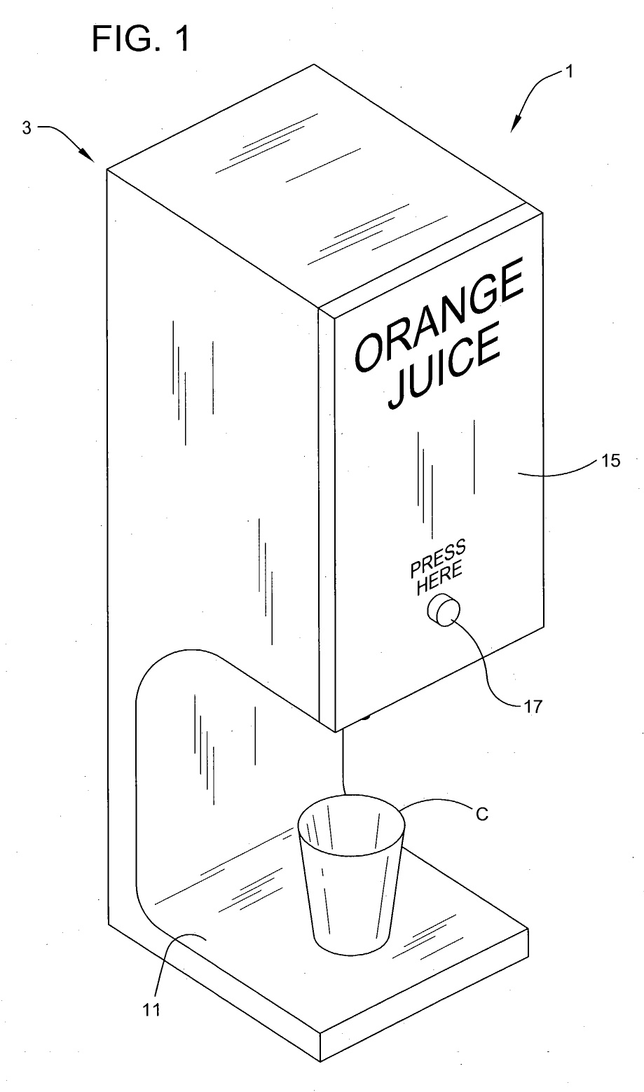

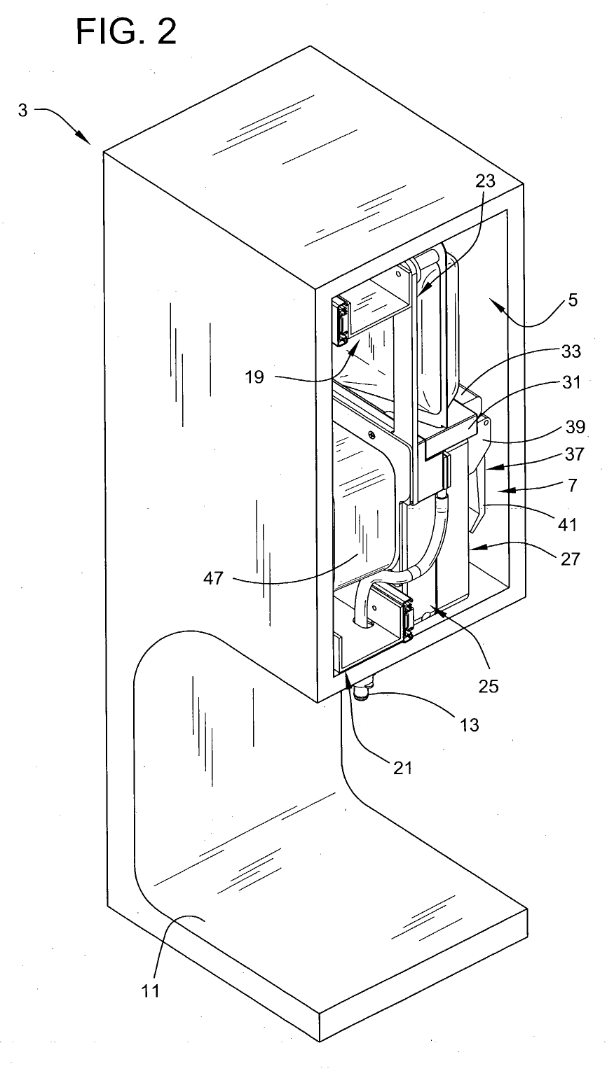

Referring now to the drawings and in particular to FIGS. 1 and 2, an orange juice dispenser constructed according to the principles of the present invention is indicated generally at 1. The orange juice dispenser comprises a rectangular housing or cabinet 3 defining a compartment 5 containing flow control apparatus 7 constructed according to the principles of the present invention for dispensing a drink from a flexible container 9 acted upon by the flow control apparatus. The foregoing reference numerals designate their subjects generally. A stand 11 (which may be formed integrally with the cabinet 3) supports the cabinet in an elevated position above the stand providing a space for placing a cup C or other suitable container below an output nozzle 13 to receive the beverage dispensed (i.e., orange juice). Although the illustrated embodiments show the invention in the context of an orange juice dispenser, the invention may be used to dispense, or mix and dispense other liquid beverages (e.g., coffee), and non-consumable liquids (e.g., paint), as well as matter which is fluent, but not liquid.

The cabinet 3 includes a front door 15 which is hinged to the remainder of the cabinet. The front door may be swung open to access the flow control apparatus 7 on the interior of the cabinet 3. For simplicity and clarity of illustration, the front door 15 has been completely removed in FIG. 2. A button 17 on the front door 15 may be pressed to actuate the flow control apparatus 7 to dispense the beverage into the cup C. The drink dispenser 1 may operate to deliver a fixed volume of the beverage each time the button 17 is pressed. Of course, levers or other types of devices (not shown) for activating the dispenser may be employed.

The flow control apparatus 7 is mounted on an upper slide and a lower slide (indicated generally at 19 and 21, respectively), both of which are fixed to the cabinet 3 within the compartment 5. Each slide 19, 21 includes telescoping sections which allow the flow control apparatus 7 to be moved out of the compartment 5 for servicing, such as by replacing the flexible container 9 with another flexible container (not shown, but of the same construction). A rectangular frame, generally indicated at 23, is connected as by bolts to the slides 19, 21 and forms the basis for connection of the other components of the flow control apparatus 7.

A fixed shell member 25 is attached to the lower end of the frame 23 and a pivoting shell member 27 is attached by hinges to the fixed shell member for pivoting about a horizontal axis extending generally along the bottom edge of the fixed shell member 25 between a closed operating position and an open position. A pair of blocks 31 (only one is shown) mounted on an upper end of the fixed shell member 25 extend outwardly from the fixed shell member in the direction of the pivoting shell member 27. The blocks 31 mount respective latch receptacles 33 (only one is shown) for releasably connecting respective latching mechanisms, generally indicated at 37, attached to the pivoting shell member 27. The latching mechanisms 37 each include a base 39, a lever 41 pivotally mounted on the base operable to release the latching mechanism from the latch receptacle.

The construction of the dispenser 1 is similar to that shown and described in co-assigned U.S. patent application Ser. No. 10/351,006. However, the pivoting shell member 27 provides a reaction surface for a lower portion of the flexible container 9. No fluid pressure is applied to the flexible container through the pivoting shell member 27 in the illustrated embodiment, although such a construction is not excluded from the scope of the present invention. Other constructions for holding the flexible container 9 could be used without departing from the scope of the present invention. Among other things, it is envisioned that the flexible container could be sufficiently rigid to hold itself to the fixed shell member 25 using clips or the like (not shown) which do not completely cover one side of the lower portion of the flexible container 9. In that event, the pivoting shell member 27 could be eliminated.

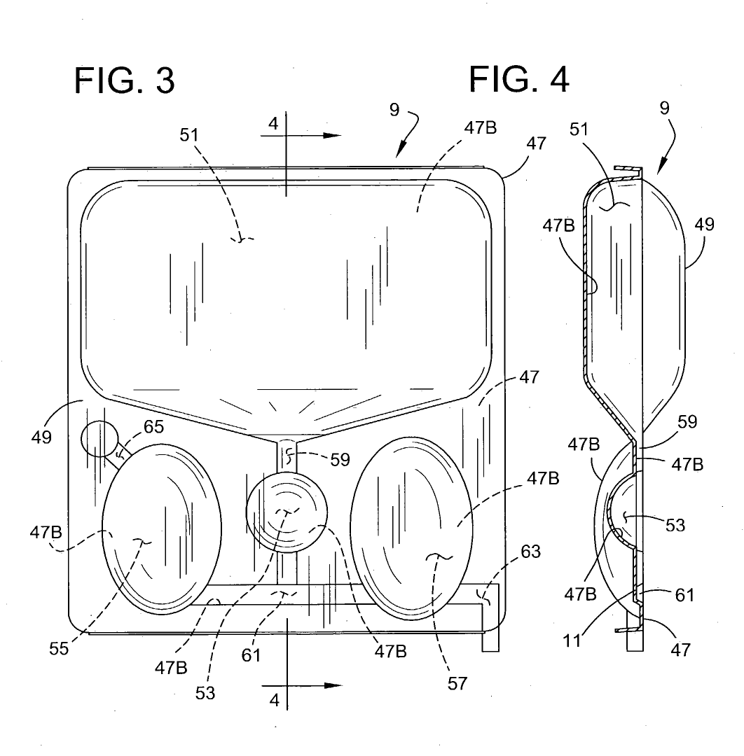

Referring now to FIGS. 3 and 4, the flexible container of the present invention comprises first and second opposed elements shown in the form of a tray 47 and a cover sheet 49. The tray and cover sheet define a reservoir cell 51, a concentrate metering cell 53, a water metering cell 55 and a mixing cell 57. The tray 47 and cover sheet 49 are generally sealingly connected at the peripheries of the respective cells, and are unconnected where they oppose each other in the cells, defining a volume for receiving a fluent material. The cells 51, 53, 55, 57 are sealed off except where they communicate with certain passages defined in the flexible container 9. A first passage 59 leads from the reservoir cell 51 to the concentrate metering cell 53. A second passage 61 provides a path for concentrate from the concentrate metering cell 53 and water from the water metering cell 55 to the mixing cell 57. A third or outlet passage 63 leads from the mixing cell 57 out of the flexible container 9. A fourth or inlet passage 65 allows water to be introduced into the water metering cell 55 from a source of water (e.g., utility water supply) outside the flexible container 9 and outside the dispenser 1. Although a utility or mains water supply is referred to herein, any suitable source of water under pressure may be used. The tray 47 and cover sheet 49 are sealed together along the side edges of the various passages 59, 61, 63, 65. The tray 42 and cover sheet 49 are unsealed over the passages and where the passages intersect the various cells 51, 53, 55, 57.

The tray 47 is made (e.g., vacuum formed) from a relatively rigid plastic (e.g., polyethylene) which generally holds its shape after formation. However, it is to be understood that a flexible container which is flexible everywhere, such as a flexible bag (not shown) made of two sheets of flexible plastic, may be used with the present invention. A face 47A of the tray 47 lies generally in a single plane with other portions recessed for use in forming the cells and passages of the flexible container 9. More particularly, the tray 47 is formed with depressions 47B of various sizes and shapes which form parts of the aforementioned cells 51, 53, 55, 57 and passages 59, 61, 63, 65. These depressions 47B generally hold their shape and position relative to the face 47A after the tray 47 is formed. The cover sheet 49 is a sheet of flexible plastic which is capable of resiliently stretching. The cover sheet 49 is sealed in a suitable manner to the face 47A of the tray 47, but is unsecured to the tray where it is in registration with the depressions 47B formed in the tray. In this way, the cells 51, 53, 55, 57 and passages 59, 61, 63, 65 are formed.

Referring to FIG. 4, the portion of the cover sheet 49 defining part of the reservoir cell 51 is shown distended as it would be when filled with orange juice concentrate. As will become apparent, the flexibility and elasticity of the cover sheet 49 allows the orange juice concentrate and water to be metered and mixed within the flexible container 9. The more rigid tray 47 serves as a frame for the container 9 so that it can generally hold its shape when filled with orange juice concentrate and shipped. This has advantages, including making the flexible container 9 more robust in shipping and handling, as well as making it easier to pack together with other flexible containers in a small space (not shown). Materials other than orange juice concentrate may be packaged in the flexible container 9, including inedible materials such as paint. Further, a single flexible container (not shown) may package more than one material in their own reservoir cells.

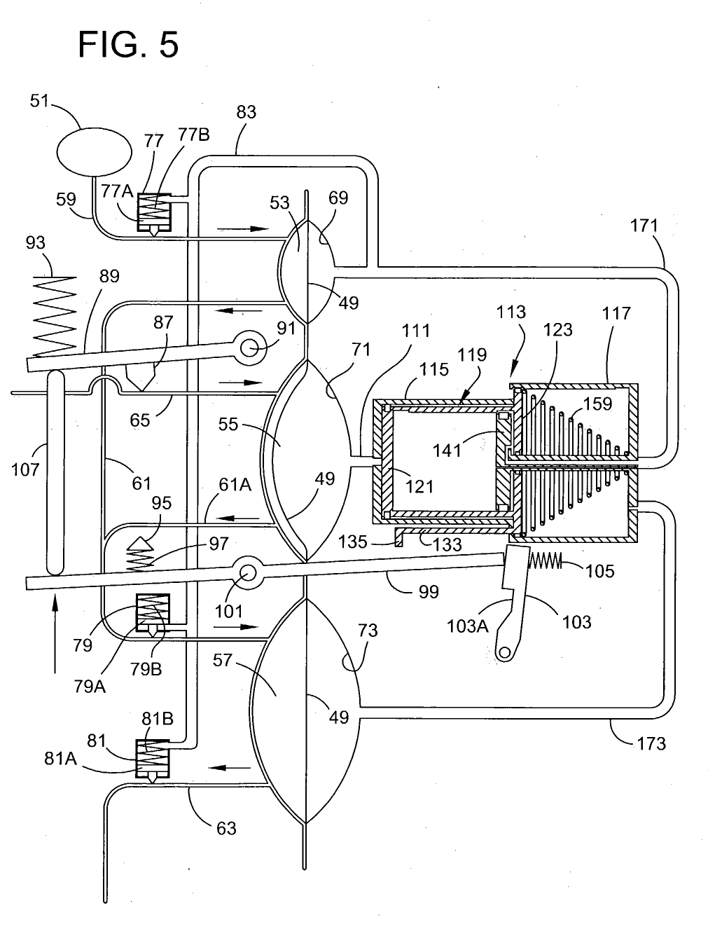

Referring now to FIG. 5, a schematic illustration of the flow control apparatus 7 of the present invention is shown to comprise a first pressure vessel 69 which is formed by a recess in the portion of the surface of the fixed shell member 25 which faces the concentrate metering cell 53 of the flexible container 9 when the container is received in the flow control apparatus 7 as shown in FIG. 2. A second pressure vessel 71 is formed by another recess in the fixed shell member 25 facing the water metering cell 55 of the flexible container 9, and a third pressure vessel 73 is formed by yet another recess facing the mixing cell 57. An O-ring or other suitable sealing member (not shown) is held by the fixed shell member 25 in position around the periphery of each of the recesses. There is one O-ring for each recess, although a greater or lesser number of O-rings could be used within the scope of the present invention. Thus when the pivoting shell member is closed, it presses the cover sheet 49 of the flexible container 9 tightly against the O-ring so that each O-ring and the corresponding cell of the flexible container form a gas-tight seal of the respective pressure vessel 69, 71, 73.

The flow control apparatus 7 further includes a first pneumatic valve 77 mounted on the fixed shell member 25 and arranged for selectively closing and opening the first passage 59 from the reservoir cell 51 to the concentrate metering cell 53. The valve 77 operates to close the first passage 59 by extending to engage the cover sheet 49 and deflect it downwardly into the depression 47B in the tray 47 which forms the first passage. The cover sheet 49 stretches and resiliently deforms so that the first passage 59 is occluded and no concentrate may pass from the reservoir cell 51 to the concentrate metering cell 53. When the first pneumatic valve 77 is retracted, the cover sheet 49 resiliently resumes its original condition spaced from the tray 47 so that concentrate may move through the first passage 59. It is noted that gravity is used to feed concentrate to the concentrate metering cell 53 in concert with the vacuum applied by expansion of the concentrate metering cell 53. However, it is envisioned that pressure could be applied to the reservoir cell 51 to facilitate flow of viscous fluent materials.

A second pneumatic valve 79 is located by the fixed shell member 25 to engage the cover sheet 49 over second passage 61 when the valve is in its closed position to occlude the second passage and prevent orange juice concentrate and water from entering the mixing cell 57. A third pneumatic valve 81 is located by the fixed shell member 25 to deform the cover sheet 49 into the third passage 63 in a closed position of the valve. Closure of the third passage 63 prevents the concentrate and water mixture from passing out of the mixing cell 57 to the outlet nozzle 13 (FIG. 2). The operation of the second and third pneumatic valves 79, 81 to occlude the second and third passages 61, 63 is substantially the same as for the first pneumatic valve 77. It is noted that the first, second and third pneumatic valves 77, 79, 81 all are spring-biased to their closed positions. All of the pneumatic valves are in fluid communication with an air line branch 83. The details of their pneumatic actuation will be described below.

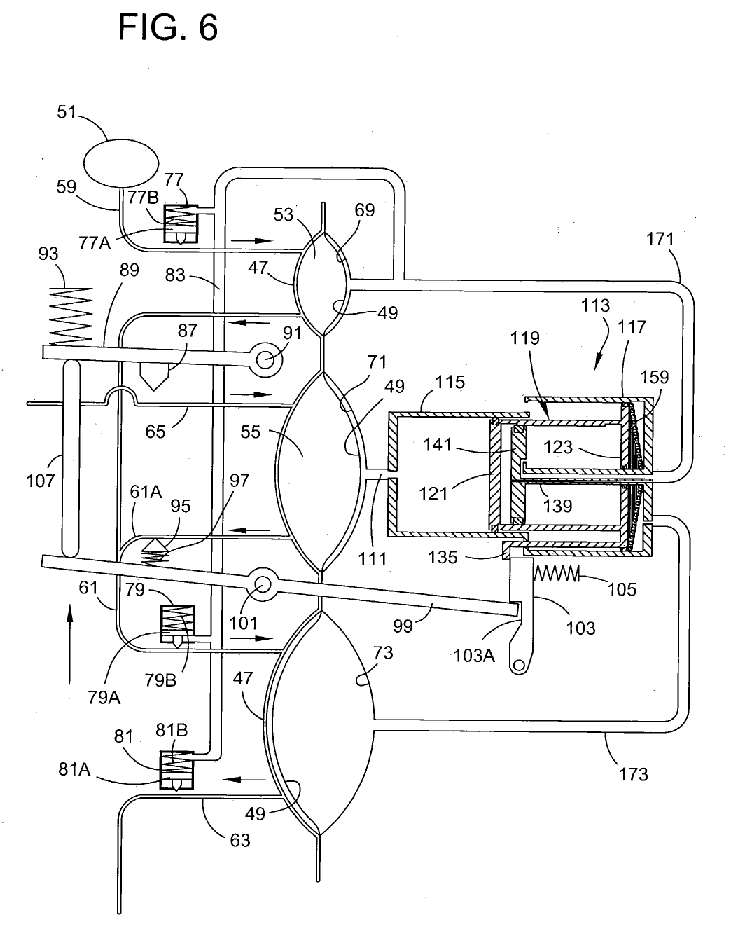

A first mechanical valve 87 is positioned for engagement with the cover sheet 49 over the fourth (inlet) passage 65 to deflect the cover sheet into the fourth passage to prevent the flow of water into the water metering cell 55. The valve 87 is schematically illustrated as being attached to an inlet lever 89 mounted on a first pivot 91. A spring 93 urges the inlet lever 89 to a position in which the valve 87 is closed. A second mechanical valve 95 is arranged for engaging the cover sheet 49 over a branch 61A of the second passage 61 leading from the water metering cell 55 to deform the cover sheet into the second passage branch and prevent water from exiting the water metering cell 55 in the second passage. The second mechanical valve 95 is schematically illustrated as being mounted by a spring 97 to an outlet lever 99 mounted on a second pivot 101. The spring 97 biases the outlet lever 99 and valve 95 to an open position permitting flow of water out of the water metering cell 55 into the second passage 61 and to the mixing cell 57. A catch 103 is located adjacent to an end of the outlet lever 99 on the opposite side of the second pivot 101 from the second mechanical valve 95. The catch 103 is mounted for pivoting and has a notch 103A which captures the end of the outlet lever 99 when it pivots to a closed position (FIG. 6). A spring 105 urges the catch 103 to pivot counterclockwise (as oriented in FIG. 5) to capture and hold the end of the outlet lever 99 in the notch 103A. A linkage, schematically represented by a single link 107 in FIG. 5, connects the outlet lever 99 to the inlet lever 89 so that pivoting of one produces pivoting of the other, as will be more fully described.

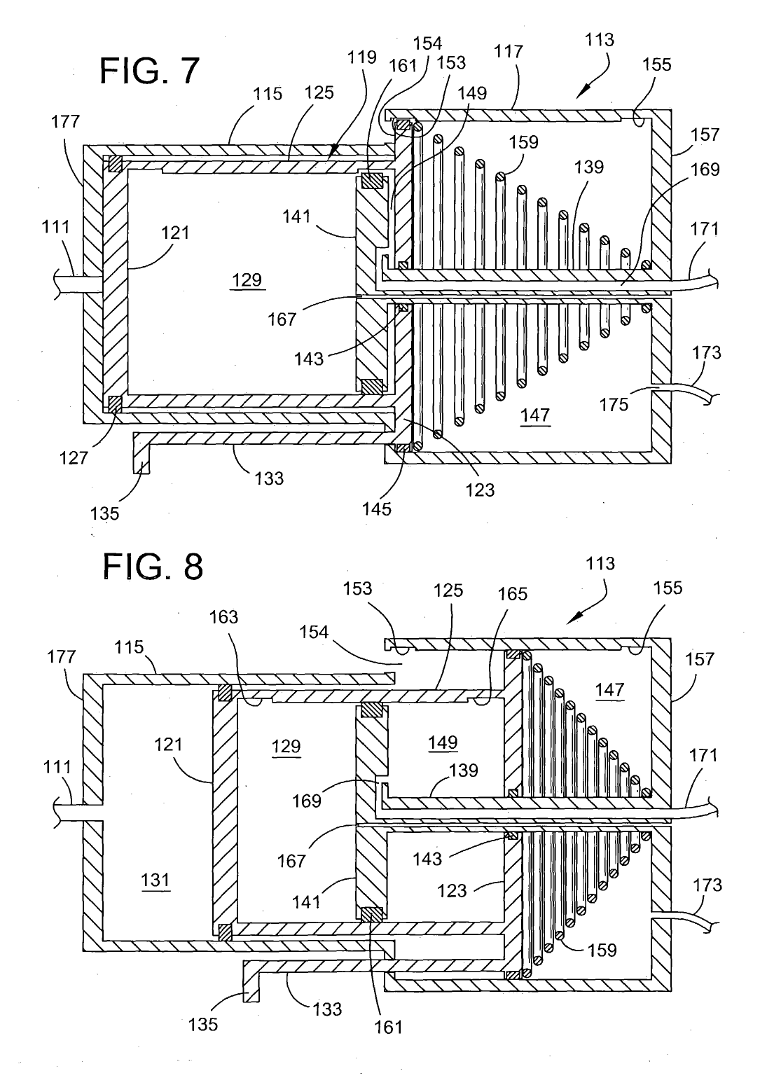

The second pressure vessel 71 (associated with the water metering cell 55) is connected by a conduit 111 to a pressure/vacuum converter (indicated generally at 113), and forms part of the pressure/vacuum converter. Enlarged, fragmentary views of the pressure/vacuum converter 113 in different stages of operation are shown in FIGS. 7-9. The pressure/vacuum converter 113 includes a first cylinder 115 connected to the conduit 111 for fluid communication with the second pressure vessel 71 and a second cylinder 117 mounted generally co-axially with the first cylinder. A piston generally indicated at 119 includes a first head 121 located in the first cylinder 115 and a second head 123 in the second cylinder 117 connected to the first head by a cylindrical tube 125. Thus, the piston 119 of the illustrated embodiment is essentially a hollow cylinder. The first head 121 mounts an O-ring 127 which engages the inner surface of the first cylinder 115 in sliding, sealing engagement. Several O-rings are shown and described in the illustrated embodiment, it being understood that other suitable sealing arrangements may be employed without departing from the scope of the present invention. The O-ring 127 and first piston head 121 fluidically divide first cylinder 115 into a first region 129 (corresponding to the portion of the interior of the cylindrical tube 125 located within the first cylinder 115), and a second region 131 (see FIG. 8).

A leg 133 extends from a peripheral edge of the second piston head 123 and through the second cylinder 117 to a location exterior of the second cylinder. The end of the leg 133 has an outwardly projecting foot 135. The leg 133 and foot 135 move conjointly with the second head 123. When the piston 119 reaches the position illustrated in FIG. 6, the foot 135 engages the catch 103. Further movement of the piston 119 in the outward stroke pivots the catch 103 in a clockwise direction against the bias of the spring 105. The end of the outlet lever 99 is released from the notch 103A. The spring 97 associated with the second mechanical valve 95 moves the outlet lever 99 back to the position shown in FIG. 5. This also allows the spring 93 to move the first lever 89 and first mechanical valve 87 from the position shown in FIG. 6 back to the FIG. 5 position.

The second cylinder 117 includes a central column 139 which extends into the first cylinder 115 and terminates in a disk-shaped divider 141 supported by the column and separating the first cylinder 115 and the second cylinder. The central column 139 extends through the second piston head 123 in an opening containing an O-ring 143 (or other suitable seal) in sliding, sealing engagement with the central column. The periphery of the second piston head 123 mounts another O-ring 145 which is capable of slidingly and sealingly engaging an interior surface of the second cylinder 117. The sealing connection of the second piston head 123 with the interior surface and the central column 139 allows the second piston head to fluidically divide the second cylinder 117 into a first region 147 and a second region 149 (FIG. 8). It is noted that the second region 149 is defined within the piston 119 as it moves into the second cylinder 117.

As will be described more fully below, the seal between the second piston head 123 and the second cylinder 117 is selectively broken in operation. For this purpose, a first arcuate channel 153 in the inner surface of the second cylinder 117 extends in a circumferential direction of the second cylinder near the first cylinder 115. An arcuate slot 154 in the second cylinder 117 near the first arcuate channel 153 opens to the ambient pressure air surrounding the second cylinder. A second arcuate channel 155 is located near end wall 157 of the second cylinder 117. A conical spring 159 is located in the second cylinder 117 between the second piston head 123 and the end wall 157 of the second cylinder opposite the first cylinder 115. The conical spring 159 biases the piston 119 to the position shown in FIG. 7.

The divider 141 mounts an O-ring 161 in a circumferential surface for sliding and sealing engagement with an inner surface of the cylindrical tube 125 of the piston 119. The divider 141 acts like a third piston head, dividing the interior of the piston 119 two regions (corresponding to the first region 129 of the first cylinder 115 and the second region 149 of the second cylinder 117). The seal of the O-ring 161 is selectively broken in operation, as will be described hereinafter. In that regard, the inner surface of the cylindrical tube 125 is formed with a first arcuate channel 163 extending in a circumferential direction near the first piston head 121, and a second arcuate channel 165 near the second piston head 123. It will be understood that the interior of the cylindrical tube 125 of the piston 119 acts as a third cylinder in the pressure/vacuum converter 113. The central column 139 has two axially extending passages which open through the end wall of the second cylinder 117. A first of the passages 167 also opens through the divider 141 into the first region 129 of the piston 119, continuously providing fluid communication between the first region and atmosphere. A second of the passages 169 turns through 180° within the divider 141 to open into the second region 149 of the second cylinder 117.

A first air line 171 is connected to the second passage 169 of the pressure/vacuum converter 113 and extends to the first pressure vessel 69 and to all three of the pneumatic valves 77, 79, 81 by way of the branch 83 of the air line (FIG. 5). The first air line 171 is in fluid communication with the second region 149 of the second cylinder 117. Fluid pressure communicated through the first air line 171 operates on the concentrate metering cell 53 of the flexible container 9 and controls operation of the pneumatic valves 77, 79, 81. It may be seen that the first air line branch 83 enters the first pneumatic valve 77 at a location behind a head 77A of the valve. Thus when the first air line 171 and branch 83 experience positive pressure, a spring 77B of the valve 77 is allowed to close the first pneumatic valve, shutting off the flow of concentrate from the reservoir cell 51 to the concentrate metering cell 53. Vacuum pressure in the first air line branch 83 results in the head 77A of the first pneumatic valve 77 being moved to the open position against the bias of the spring 77B so that concentrate may flow from the reservoir cell 51 to the concentrate metering cell 53. The second pneumatic valve 79 connects to the branch 83 of the first air line 171 at a location on an opposite side of a head 79A of the valve from a spring 79B. Accordingly, positive pressure in the first air line 171 results in the second pneumatic valve 79 being opened. Vacuum pressure in the first air line branch 83 closes the valve in concert with the spring 79B. The third pneumatic valve 81 is connected to the branch 83 of the first air line 171 in the same way as the first (on the same side of a head 81A of the valve as a spring 81B), and operates in the same fashion in response to positive and negative air pressure in the first air line branch 83.

A second air line 173 is connected to the second cylinder 117 in an opening 175 in the end wall 157 of the second cylinder so that the second air line communicates with the first region 147 of the second cylinder (see FIG. 7). The second air line 173 extends to the third pressure vessel 73. It will be apparent that positive and negative air pressure in the second air line 173 will operate on the mixing cell 57 of the flexible container 9. Although the lines are referred to as containing “air”, any gas or other fluent material capable of transmitting pressure to the various components could be used without departing from the scope of the present invention.

Having described the construction of the dispenser 1 and its flow control apparatus 7, its operation to dispense a metered quantity of orange juice mixed from concentrate and utility water will be described. It is noted that the dispenser 1 operates without requiring electricity. As an initial matter, a flexible container 9 previously packaged with orange juice concentrate will be installed in the dispenser. The door 15 of the dispenser 1 is opened and the flow control apparatus 7 is moved out using the slides 19, 21 (FIG. 2). The pivoting shell member 27 is unlatched and swung down so that a lower portion of the flexible container 9 may be placed against the fixed shell member 25. The flexible container 9 is hung on the frame 23 so that it remains in this position. The pivoting shell member 27 is swung back up and latched to hold the flexible container 9 securely against the fixed shell member 25 and promote sealing of the flexible container around the pressure vessels 69, 71, 73 defined in the fixed shell member 25. In this installation process, the flexible container 9 is attached to a utility water line (not shown). The flexible container 9 is hooked up to the output nozzle 13 and the flow control apparatus 7 slides back into the dispenser compartment 5. The door 15 is shut and the flow control apparatus 7 is cycled a as necessary so that a diluted volume of orange juice is held in the mixing cell 57. The dispenser 1 is ready for operation.

Someone desiring orange juice places the cup C below the output nozzle 13 of the dispenser and presses the button 17. Prior to the button being depressed, the configuration of the flow control apparatus 7 is as shown in FIG. 5. The first mechanical valve 87 is closed, preventing water from the water line and fourth (inlet) passage 65 from entering the water metering cell 55. The second mechanical valve 95 is open. The conical spring 159 of the pressure/vacuum converter 113 urges the piston 119 so that the first head 121 abuts an end wall 177 of the first cylinder 115, applying a positive gas pressure to the second pressure vessel 71 and flexible cover sheet 49 over the water metering cell 55, which collapses the cover sheet against the tray 47.

The first air line 171 (and branch 83) is at ambient pressure. Referring to FIG. 7, the second passage 169 and second region 149 of the second cylinder 117 are in fluid communication with the first region 129 of the first cylinder 115 because the O-ring 161 of the divider 141 is in registration with the second arcuate channel 165 of the piston 119. The first region 129 is continuously vented to atmosphere by the first passage 167. Therefore, the air line 171 and branch 83 are also at atmospheric pressure. In that condition, all of the pneumatic valves 77, 79, 81 are closed and neutral pressure is applied to the concentrate metering cell 53 in the first pressure vessel 69. The first region 147 of the second cylinder 117 and second air line 173 are also vented to atmosphere in this position. More specifically, the first region 147 (to which the second air line 173 is connected) communicates with ambient pressure surrounding the pressure/vacuum converter 113 because the O-ring 145 associated with the second piston head 123 is in registration with the first arcuate channel 153 of the second cylinder 117. Thus, air is able to pass the O-ring 145 into the first region 147 to maintain the region at atmospheric pressure. As a result, no positive or vacuum pressure is applied via the second air line 173 to the third pressure vessel 73 or to the cover sheet 49 overlying the mixing cell 57.

As the button 17 is depressed, the outlet lever 99 is pivoted clockwise (in the orientation shown in FIG. 5) from the FIG. 5 position to the FIG. 6 position. One end of the outlet lever 99 pushes the catch 103 to pivot clockwise against the bias of the spring 105 until the end is aligned with the notch 103A. The spring 105 then moves the catch 103 counterclockwise so that the end of the outlet lever 99 is captured in the notch 103A, holding the outlet lever in position. The movement of outlet lever 99 brings the second mechanical valve 95 into engagement with the second passage 61 to prevent fluid from exiting the water metering cell 55. At the same time the outlet lever 99 is pivoting, link 105 transfers this motion to inlet lever 89, causing it to pivot in the clockwise direction and move the first mechanical valve 87 away from the inlet passage 65.

The opening of inlet passage 65 allows water under, for example, normal water main pressure, to enter the water metering cell 55. The water fills the cell 55 and distends the portion of the cover sheet 49 defining part of the water metering cell 55 into the second pressure vessel 71. In the illustrated embodiments, the water metering cell 55 of the flexible container 9 constitutes “a first bladder” and the cover sheet 49 is the portion of the first bladder which expands into the second pressure vessel 71. The concentrate metering cell 253 constitutes “a second bladder” and the cover sheet 49 is the portion of the second bladder which expands into the first pressure vessel 69. It is to be understood that a bladder within the scope of the present invention may have other configurations. The movement of the cover sheet 49 into the second pressure vessel 71 causes the air pressure in the vessel to increase. The higher air pressure is communicated to the second region 131 of the first cylinder 115 through conduit 111 to the first head 121 of the piston 119. The piston begins to move to the right (in the orientation of FIGS. 5-9) against the bias of the conical spring 159 as air flows into the second region 131 of the first cylinder 115 from the second pressure vessel 71.

Movement of the piston 119 from the initial position shown in FIGS. 5 and 7 causes the second piston head 123 and O-ring 145 to move out of registration with the first arcuate channel 153 in the second cylinder. As may be seen in FIG. 8, the O-ring 145 engages the interior wall of the second cylinder 117, fluidically isolating the first region 147 of the second cylinder from ambient. Accordingly, air pressure builds in the first region 147 and this is communicated by the second air line 173 to the third pressure vessel 73. The pressure deforms the cover sheet 49 against the tray 47 in the mixing cell 57 so that a mixture of orange concentrate and water (i.e., ready to drink orange juice) is forced out of the mixing cell 57, through the outlet passage 63, to the nozzle 13 and into the waiting cup C. The mixing cell 57 is sized so as to dispense an amount of orange juice (e.g., 6 oz.) suitable for a single serving. Of course, the mixing cell 57 and dispenser could be configured to dispense any suitable amount. In the following description, it will become apparent how the mixture of water and orange juice came to be in the metering cell 57 for dispensing to the cup C.

Referring to FIGS. 6 and 8, the travel of the piston 119 to the right moves the cylindrical tube 125 of the piston so that the divider 141 and O-ring 161 are out of registration with the second arcuate channel 165 in the piston. The O-ring 161 now seals with the cylindrical tube 125 around the full circumference of the O-ring. The second region 149 is fluidically isolated from ambient, and begins to expand in volume. The expansion produces a vacuum pressure within the second region 149 which is communicated to the first air line 171 by way of the second passage 169. The first air line 171 transmits the vacuum pressure to the first pressure vessel 69 and to the portion of the cover sheet 49 defining part of the concentrate metering cell 53. The part of the cover sheet 49 associated with the concentrate metering cell 53 expands into the first pressure vessel 69 for drawing concentrate from the reservoir cell 51 into the concentrate metering cell. The amount of concentrate drawn into the metering cell 53 is determined by the volume of the recess 47B in the tray 47 plus the volume of the first pressure vessel 69. In this way, a metered dose of orange juice concentrate is measured out for subsequent mixing and dispensing by the dispenser 1.

The vacuum pressure applied to the first air line 171 is used to open the first passage 59 and the outlet passage 63. The vacuum pressure is communicated to branch 83, which is connected to the pneumatic valves 77, 79, 81. The first pneumatic valve 77 opens upon application of vacuum pressure against the bias of the spring 77B to open the first passage 59, allowing concentrate to flow from the reservoir cell 51 to the metering cell 53. The vacuum pressure in the branch 83 causes the third pneumatic valve 81 to open so that the mixture of orange juice concentrate and water can pass out of the mixing cell 57 through the outlet passage 63 to be dispensed. However, the connection of the branch 83 to the second pneumatic valve 79 causes the valve to remain closed so that concentrate from the concentrate metering cell 53 and water from the water metering cell 55 cannot flow into the mixing cell 57.

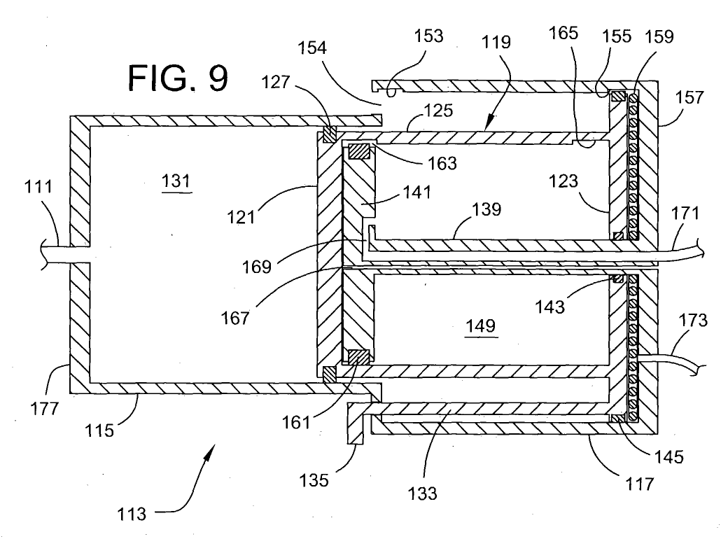

FIG. 6 illustrates the pressure/vacuum converter 113 as the piston 119 nears the end of its (outward) stroke to the right (as oriented in FIG. 6). The foot 135 of the leg 133 extending from the second piston head 123 of the piston 119 is shown just as it engages the catch 103. Continued movement to the right to the end of the stroke of the piston (shown in FIG. 9) moves the catch 103 up against the bias of the spring 105 so that the end of the outlet lever 99 moves out of the notch 103A of the catch. The spring 97 of the second mechanical valve 95 then causes the outlet lever 99 to pivot counterclockwise back to the FIG. 5 position. The second mechanical valve 95 moves to an open position so that water is permitted to move out of the water metering cell 55. Movement of the outlet lever 99 is actuated by the spring 93 of the inlet lever 89 through the link 107. The outlet lever 89 also pivots in a counterclockwise direction to close the fourth passage 65 so that mains water is prevented from flowing into the water metering cell 55. At this time, a vacuum is being applied to the concentrate metering cell 53 and water metering cell 55 so that there is substantially no flow of concentrate or water out of either cell.

When the piston 119 reaches the end of its rightward stroke as shown in FIG. 9, the conical spring 159 is pushed nearly flat against the end wall 157 of the second cylinder 117. The O-ring 145 on the second head 123 of the piston 119 is aligned with the second arcuate channel 155 in the interior wall of the second cylinder 117. The first region 147 and second air line 173 are now open to the ambient pressure because air can pass around the second piston head 123 and O-ring 145 in the second arcuate channel 155 and thence through the arcuate slot 154. The pressure in the first region 147 and second air line 173 returns from a positive pressure to ambient. Accordingly, the air pressure in the third pressure vessel 73 over the mixing cell 73 is relieved and the cover sheet 49 moves back to a relaxed configuration spaced from the tray 47.

The first arcuate channel 163 in the cylindrical tube 125 of the piston is aligned with the O-ring 161 of the divider 141 at the right end of the piston stroke (FIG. 9). This places the second region 149 of the second cylinder 117 and the first air line 171 in communication with air at ambient pressure by way of the first passage 167 in the column 139. Air is able to flow around the O-ring 161 in the first arcuate channel 163 into the second region and into the first air line 171 via the second passage 169 in the column 139. Vacuum pressure is relieved from the first pressure vessel 69 and concentrate metering cell 53 which is now filled with orange juice concentrate. Ambient pressure is communicated through the branch 83, so that the first pneumatic valve 77 is pushed closed by the spring 77B, closing the first passage 59 from the reservoir cell 51. The second pneumatic valve 79 remains closed even though the vacuum pressure under the head 79A is removed because of the bias of the spring 79B. The third pneumatic valve 81 closes under the force of its spring 81B so no additional liquid from the mixing cell 57 is dispensed.

The conical spring 159 begins to push the piston 119 back to the left (as oriented in FIGS. 5-9) from the position shown in FIG. 9. As the second head 123 of the piston 119 moves away from the end wall 157, the O-ring 145 moves out of registration with the second arcuate channel 155 of the second cylinder 117, again sealing the first region 147 of the second cylinder from atmosphere. The first region 147 expands in volume, creating a vacuum in the region which is communicated by way of the second air line 173 to the third pressure vessel 73. The part of the cover sheet 49 which defines a portion of the mixing cell 57 expands into the third pressure vessel 73 to draw in concentrate and water from the concentrate metering cell 53 and water metering cell 55 (respectively).

As the first head 121 of the piston 119 moves in a return stroke from the FIG. 9 position back toward the FIG. 8 position, the volume of the second region 131 of the first cylinder 115 is reduced. Therefore, pressure is applied through the conduit 111 to the second pressure vessel 71 and against the portion of the cover sheet 49 forming part of the water metering cell 55. The cover sheet 49 is pushed, as the piston 119 progresses further to the left, down against the tray 47 in the region of the water metering cell 55, causing water to be forced out of the cell, into the second passage 61 and to the mixing cell 57.

Movement of the piston 119 to the left also causes the first arcuate channel 163 to be moved out of registration with the O-ring 161 of the divider 141. The second region 149 of the second cylinder 117 is again sealed from ambient so that continued movement of the piston 119 causes fluid pressure to build in the second region. This pressure is communicated via the second passage 169 in the column 139 to the first air line 171 and the first pressure vessel 69. The part of the cover sheet 49 which defines a portion of the concentrate metering cell 53 is collapsed toward the tray 47 of the flexible container 9. Orange juice concentrate is thus forced out of the concentrate metering cell 53 into the second passage 61 and to the mixing cell 57. The concentrate mixes with the water from the water metering cell 55 as both travel to the mixing cell in the second passage 61 at substantially the same time. Thus, it is not necessary for any additional mixing to occur within the mixing cell 57.

As the piston 119 reaches the end of its return stroke, the O-ring 145 on the second head 123 comes into alignment with the first arcuate channel 153 of the second cylinder 117. The first region 147 of the second cylinder is again able to communicate with ambient pressure through the first arcuate channel 153 and arcuate slot 154. Vacuum pressure in the first region 147 and in the second air line 173 is relieved. The mixing cell 57 is also no longer subject to vacuum pressure. However, the mixed orange juice is not dispensed because the third pneumatic valve 81 remains closed, and as will be momentarily described, the second pneumatic valve 79 also closes. Thus, the orange juice is held in the mixing cell 81 pending the next activation of the dispenser 1.

The end of the return stroke of the piston 119 also places the second arcuate channel 165 in the cylindrical tube 125 of the piston in registration with the O-ring 161 of the divider 141. The second region 149 of the second cylinder 117 communicates with ambient pressure by way of the second arcuate channel 165 and the first passage 167 in the column. The positive pressure in first air line 171 is also relieved to ambient. The portion of the cover sheet 49 associated with the concentrate metering cell 53 may then return under its own resiliency to a relaxed position from a position abutting the tray 47 in the recess 47A defining part of the concentrate metering cell. A return to ambient pressure in the branch 83 of the first air line 171 has no effect on the first pneumatic valve 77 which remains closed because of the force of the spring 77A, or on the third pneumatic valve 81 which remains closed under the force of the spring 81B. The second pneumatic valve 79 moves from an open position by operation of the spring 79B as pressure is relieved under the head 79A to a closed position blocking entry of liquid into the mixing cell 57. The dispenser 1 is now ready to dispense mixed orange juice when the button 17 is depressed.

In view of the above, it will be seen that the several objects of the invention are achieved and other advantageous results attained.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above without departing from the scope of the invention, it is intended that all matter contained in the above description and shown in the accompanying drawings shall be interpreted as illustrative and not in a limiting sense.

1. A pressure/vacuum converting machine for converting an input force from an expandable bladder into at least one pneumatic actuation force, the converting machine comprising a pressure vessel adapted to receive at least a portion of the bladder therein and defining a gas volume not occupied by the bladder within the vessel, the gas volume of the pressure vessel decreasing as the bladder expands thereby increasing the gas pressure in the gas volume, a pneumatic actuator in fluid communication with the gas volume of the pressure vessel such that pressure in the gas volume drives operation of the pneumatic actuator.

2. A pressure/vacuum converting machine as set forth in claim 1 wherein the pneumatic actuator has a force output comprising a positive pressure output and a negative pressure output, the positive and negative pressure outputs occurring at least partially at the same time.

3. A pressure/vacuum converting machine as set forth in claim 2 wherein further comprising an energy storage device arranged with respect to the pneumatic actuator for storing energy created by the increased pressure in the pressure vessel as a result of expansion of the bladder into the pressure vessel.

4. A pressure/vacuum machine as set forth in claim 3 wherein the pneumatic actuator comprises a cylinder and a piston head slidingly and sealingly received for movement within the cylinder, the piston head being adapted to move under influence of increased gas pressure from the pressure vessel.

5. A pressure/vacuum machine as set forth in claim 4 wherein the energy storage device comprising a spring operatively engaging the piston head and yieldably opposing said movement of the piston head under influence of increased gas pressure from the pressure vessel.

6. A pressure/vacuum machine as set forth in claim 4 wherein the piston head divides the cylinder into two regions, one of the regions being in fluid communication with the gas volume of the pressure vessel and the other region being blocked by the piston head from fluid communication with the gas volume, the cylinder being constructed to maintain said other volume substantially at a neutral pressure as the piston head moves in the cylinder.

7. A pressure/vacuum machine as set forth in claim 4 wherein the cylinder and piston head of the pneumatic actuator comprises a first cylinder and a first piston head, and wherein the pneumatic actuator further comprises a second cylinder and a second piston head adapted for sliding and sealing engagement in the second cylinder to divide the second cylinder into two regions, the second piston head being operatively connected to the first piston head for conjoint movement therewith.

8. A pressure/vacuum machine as set forth in claim 1 wherein the pneumatic actuator comprises a cylinder and a piston head slidingly and sealingly received for movement within the cylinder, the piston head being adapted to move under influence of increased gas pressure from the pressure vessel.

9. A pressure/vacuum machine as set forth in claim 8 wherein the piston head divides the cylinder into two regions, one of the regions being in fluid communication with the gas volume of the pressure vessel and the other region being blocked by the piston head from fluid communication with the gas volume, the cylinder being constructed to maintain said other volume substantially at a neutral pressure as the piston head moves in the cylinder.

10. A pressure/vacuum machine as set forth in claim 8 wherein the cylinder and piston head of the pneumatic actuator comprises a first cylinder and a first piston head, and wherein the pneumatic actuator further comprises a second cylinder and a second piston head adapted for sliding and sealing engagement in the second cylinder to divide the second cylinder into two regions, the second piston head being operatively connected to the first piston head for conjoint movement therewith.

11. A pressure/vacuum machine as set forth in claim 10 wherein the pressure vessel comprises a first pressure vessel, and wherein the machine further comprises a second pressure vessel adapted to at least partially receive a second bladder, and passaging connected to the second pressure vessel from the second cylinder whereby upon movement of the second piston head in one direction when the first bladder expands, vacuum pressure is applied from the second cylinder to the second pressure vessel to expand the second bladder, and upon movement of the second piston head in the opposite direction when the first bladder contracts, positive pressure is applied from the second cylinder to the second pressure vessel to compress the second bladder.

12. A pressure/vacuum machine as set forth in claim 11 further comprising a third pressure vessel adapted to at least partially receive a third bladder, and passaging connected to the third pressure vessel from the second cylinder whereby upon movement of the second piston head in one direction when the first bladder expands, positive pressure is applied from the second cylinder to the third pressure vessel to compress the third bladder, and upon movement of the second piston head in the opposite direction when the first bladder contracts, vacuum pressure is applied from the second cylinder to the third pressure vessel to expand the third bladder.

13. A pressure/vacuum machine as set forth in claim 12 in combination with the first, second and third bladders.

14. A pressure/vacuum machine as set forth in claim 13 wherein the first, second and third bladders are made of a resilient material.

15. A pressure/vacuum machine as set forth in claim 13 further comprising passaging connecting the first and second bladders to the third bladder.

16. A pressure/vacuum machine as set forth in claim 10 further comprising at least one pneumatic valve operated by the pneumatic actuator to open and close for use in controlling flow of fluent material.

17. A pressure/vacuum machine as set forth in claim 16 wherein said one pneumatic valve is connected to the pneumatic actuator so that said one pneumatic valve is open upon application of one of: positive fluid pressure and negative fluid pressure.

18. A pressure/vacuum machine as set forth in claim 17 wherein said one pneumatic valve is biased to a closed position.

19. A pressure/vacuum machine as set forth in claim 18 wherein said one pneumatic valve comprises a spring for biasing said one valve to the closed position.

20. A pressure/vacuum machine as set forth in claim 16 comprising multiple pneumatic valves, each pneumatic valve being connected to the pneumatic actuator so that each of said one pneumatic valve is open upon application of one of: positive fluid pressure and negative fluid pressure.

21. A pressure/vacuum machine as set forth in claim 20 wherein two of said pneumatic valves are open and one of said valves is closed upon application of vacuum pressure from the pneumatic actuator.

22. A fluent material dispenser powered by fluent material from a source of fluent material under pressure to act upon a flexible container to dispense fluent material used to power the dispenser, the fluent material dispenser comprising:
a first pressure vessel sized and shaped to receive a first portion of the flexible container therein in sealing relation with the flexible container first portion;
a second pressure vessel sized and shaped to receive a second portion of the flexible container therein in sealing relation with the flexible container second portion to define a gas volume within the second pressure vessel;
a valve for selectively connecting the second portion of the flexible container to the source of fluent material under pressure such that the second portion is capable of expanding into the second pressure vessel to reduce the gas volume and increase the gas pressure in the second pressure vessel;
a pneumatic actuator in fluid communication with the gas volume of the second pressure vessel and adapted for employing energy from the increased gas pressure caused by expansion of the second portion into the second pressure vessel to deflect the first portion and move fluent material within the first portion, and to store energy to act on the second portion of the flexible container to displace fluent material therefrom when the valve is closed whereby fluent material is dispensed.

23. A fluent material dispenser as set forth in claim 22 wherein the pneumatic actuator is connected and arranged to apply a positive pressure to the first pressure vessel gas volume and first portion when the pressure of the gas volume in the second pressure vessel is increased by expansion of the second portion within the second pressure vessel.

24. A fluent material dispenser as set forth in claim 22 wherein the pneumatic actuator is connected and arranged to apply a vacuum pressure to the first pressure vessel gas volume and first portion when the pressure of the gas volume in the second pressure vessel is increased by expansion of the second portion within the second pressure vessel.

25. A fluent material dispenser as set forth in claim 24 further comprising a third pressure vessel sized and shaped to receive a third portion of the flexible container therein in sealing relation with the flexible container third portion, the third pressure vessel being connected to the pneumatic actuator so that a positive pressure is applied to the third pressure vessel and third portion when the pressure of the gas volume in the second pressure vessel is increased by expansion of the second portion within the second pressure vessel.

26. A fluent material dispenser as set forth in claim 25 wherein the valve comprises a first valve, the dispenser further comprising second and other valves for selectively flow of fluent material into and out of the first, second and third portions.

27. A fluent material dispenser as set forth in claim 26 wherein at least one of the first, second and other valves is a pneumatic valve operated by the pneumatic actuator.

28. A fluent material dispenser as set forth in claim 27 wherein said one pneumatic valve is connected to the pneumatic actuator so that said one pneumatic valve is open upon application of one of: positive fluid pressure and negative fluid pressure.

29. A fluent material dispenser as set forth in claim 28 wherein said one pneumatic valve is biased to a closed position.

30. A fluent material dispenser as set forth in claim 29 wherein said one pneumatic valve comprises a spring for biasing said one valve to the closed position.

31. A fluent material dispenser as set forth in claim 27 comprising multiple pneumatic valves, each pneumatic valve being connected to the pneumatic actuator so that it is open upon application of one of: positive fluid pressure and negative fluid pressure.

32. A fluent material dispenser as set forth in claim 31 wherein two of said pneumatic valves are open and one of said valves is closed upon application of vacuum pressure from the pneumatic actuator.

33. A fluent material dispenser as set forth in claim 26 in combination with the flexible container, the flexible container comprising passaging therein interconnecting the first, second and third portions of the flexible container and an outlet, the passaging being capable of carrying fluent material from the first and second portions to the third portion for dispensing to the outlet.

34. A fluent material dispenser in combination with the flexible container as set forth in claim 33 wherein the fluent material from the first portion is different than the fluent material from the second portion.

35. A fluent material dispenser in combination with the flexible container as set forth in claim 34 wherein the fluent material from the first portion is an beverage concentrate.

36. A fluent material dispenser in combination with the flexible container as set forth in claim 35 wherein the beverage concentrate is one of: orange juice concentrate.

37. A method for dispensing fluent material using the pressure of fluent material from a source of fluent material under pressure, the method comprising:
admitting fluent material under pressure into an elastic first bladder such that the first bladder expands in volume;
converting expansion of the elastic bladder into positive gas pressure;
driving a pneumatic actuator with the positive gas pressure to effect one of expansion and compression of an elastic second bladder to move fluent material within the second bladder;
storing energy from the positive gas pressure;
shutting off admission of fluent material under pressure into the first bladder;
driving the pneumatic actuator with the stored energy to compress the first bladder and to effect the other of expansion and compression of the second bladder for use in dispensing fluent material.

38. A method as set forth in claim 37 wherein said step of driving a pneumatic actuator with the positive gas pressure comprises driving the pneumatic actuator to give a positive pressure output and a vacuum pressure output at the same time.

39. A pneumatic valve system comprising a valve including a cylinder and a piston biased to one of a valve open position and a valve closed position, a pneumatic actuator in fluid communication with the valve for applying at least one of a positive and negative pressure to the valve, the actuator being connected to the valve to move the piston against its bias to the other of the valve open and valve closed positions upon application of said one pressure.

40. A pneumatic valve system as set forth in claim 39 wherein the valve constitutes a first valve and wherein the valve system further comprises a second valve including a cylinder and a piston biased to one of a valve open position and a valve closed position, the pneumatic actuator being in fluid communication with the second valve for applying at least one of a positive and negative pressure to the valve, the actuator being connected to the second valve to move the piston against its bias to the other of the valve open and valve closed positions upon application of said one pressure.

41. A pneumatic valve system as set forth in claim 40 wherein the first valve is moved to the valve open position upon application of one of said positive and negative pressures by the pneumatic actuator, and the second valve is moved to the valve closed position upon application of said one pressure.

42. A pneumatic valve system as set forth in claim 40 wherein the first valve further comprises a spring in the cylinder biasing the piston to the valve closed position and the second valve further comprises a spring in the cylinder biasing the piston to the valve closed position.

43. A pneumatic valve system as set forth in claim 40 further comprising a third valve including a cylinder and a piston biased to one of a valve open position and a valve closed position, the pneumatic actuator being in fluid communication with the third valve for applying at least one of a positive and negative pressure to the valve, the actuator being connected to the third valve to move the piston against its bias to the other of the valve open and valve closed positions upon application of said one pressure.
